(19) United States
(12) Patent Application Publication
(10) Pub. No.: US 2014/0083933 A1
(43) Pub. Date: Mar. 27, 2014

(54) METHOD FOR HEAVY METAL ELIMINATION OR PRECIOUS METAL RECOVERY USING MICROBIAL FUEL CELL

(71) Applicants: CHANSOO CHOI, (US); MIKE YOUNG SHIN, POMONA, CA (US)

(72) Inventor: Chansoo Choi, Daejeon (KR)

(73) Assignees: MIKE YOUNG SHIN, POMONA, CA (US); CHANSOO CHOI, DAEJEON (KR)

(21) Appl. No.: 14/114,746

(22) PCT Filed: Jul. 13, 2011
(86) PCT No.: PCT/KR2011/005141

§ 371 Date: Oct. 29, 2013

(30) Foreign Application Priority Data
May 4, 2011 (KR) 1020110042226

(51) Int. Cl. C02F 3/28; C02F 3/34

(52) U.S. Cl. CPC C02F 3/2853; C02F 3/34
USPC 210/603; 435/252.1; 435/252.7; 435/252.5

(57) ABSTRACT

The present invention relates to a method in which a microbial fuel cell (MFC) is used in order to produce electrical power while also either eliminating heavy metals or recovering precious metals from wastewater containing the heavy metals or the precious metals, and, more particularly, the invention has advantages including effective elimination of Hg²⁺ or any other heavy metals in the form of a solid precipitate or deposit of Hg or Hg₂Cl₂ or any other such deposits or effective recovery of Ag or any other precious metals in the form of solid precipitates or deposits, and incidentally, power is produced, by-products are rendered harmless and long-term economic operation is achieved.

### CROSS-REFERENCES TO RELATED APPLICATIONS

This application claims benefit under the PCT application with International Patent Number PCT/KR2011/005141 entitled “Method of Heavy Metal Elimination or Precious Metal Recovery using Microbial Fuel Cell” filed Jul. 13, 2011 in Korea, the content of which is incorporated by reference in its entirety.

### AREA OF TECHNOLOGY

The present invention relates to the method of heavy metal removal or precious metal recovery from wastewater containing such metals while generating power at the same time using microbial fuel cell (MFC).

### BACKGROUND OF TECHNOLOGY

Mercury is especially the primary cause of environmental pollution and toxicity among the heavy metals. Mercury exists in three forms such as mainly elemental mercury (Hg), inorganic mercury compound, and organic mercury compound, and the compound of these three is called mercury in general. Inorganic mercury compound consists of mercuric salts Hg⁺, mercuric salts Hg²⁺, or amalgam, and organic mercury compound consists of alkyl mercury compound. All types of mercury are extremely highly toxic, each of which has an impact to human health differently, and especially, methyl mercury and Hg²Cl² is a possible cause of human cancer. Mercury and its compound is widely used for the production of paint, pulp, and paper products, oil refining, battery manufacturing, and pharmaceutical manufacturing process. The discharge of wastewater containing mercury ion may contaminate surrounding environment, and may directly be discharged into the water system manually, or indirectly discharged into the food chain, resulting in the serious damage to human health.

The treatment processing methods of wastewater containing heavy metals including mercury are neutralizing precipitation method, solvent extraction method, membrane separation method, adsorption method, and ion exchange method. The neutralizing precipitation method and solvent extraction method may require post processing because they will cause the secondary sources of contamination. Although ion exchange method is often used as a tap water processing method, it has a disadvantage of adsorbing mineral components in the water. (Suh Jeongho, Seo Myunggyo, Kwak Youngkyu, Kang Shinmook, Noh Jongsoo, Lee Kookeui, and Choi Yoonchan, Korean Journal of Environmental Hygienic Society, 1998, 24(1), 98).

In order to complement the problems of past wastewater treatment, there are active research underway in the methods of removing heavy metals or recovering rare precious metals that are contained in the tap water, underground water and wastewater using biological adsorption. This method has a high potential for technological development, and is expected to be a promising method to remove heavy metals from the wastewater (Choi, Ikwon, “The production and its effect of adsorption material of heavy metal using seaweeds,” Master Thesis, Sooncheon University, 2004). Especially, the new technological development of heavy metal removing material using algae, and microbe is very highly evaluated for its excellent selectivity and high functionality of their marketable alternatives as compared with conventional adsorption material such as activated carbon. The biological adsorption material is globally marketable together with its application possibility is due to the fact that heavy metals are well sorbed into the carboxylate, hydroxylamine sulfate, phosphate and amino ligands which exist in the cell wall of microbes that consist of polysaccharide, protein, and fat. Also, microbial adsorption material is easily available from fermentation process or waste biomass from wastewater treatment facility, and affordable and economic because it is available without additional processing of waste resources. And as a microbe has a property to sorb selectively specific heavy metals depend on its kinds, it is possible to use them in the treatment of toxic heavy metals in the industrial wastewater and the recovery of highly valuable heavy metals (Suh Jeongho, Seo Myunggyo, Kang Shinmook, Lee Kookeui, Choi Yoonchan, Cho Jeongkoo, and Kim Euiyong, Korean Journal of Environmental Hygienic Society, 1997, 23(4), 21).

Microbial fuel cell is recently used to purify the pollutants such as wastewater and sediment because the electrons which are generated in the process of the microbial decomposing organics will be sent to the cathode part and generate voltage. For example, the Korean patent disclosure number 10-200300038240 (May 16, 2003) publishes that biochemical oxygen demand meter using low nutritional electrochemical active microbes, and the biochemical low concentration oxygen demand metering method using such microbes. Also, Korean patent disclosure number 10-2008-0066460 (Jul. 16, 2008) publishes a device that reduces the production of sludge by limiting the growth of the microbes transferring the energy from the decomposition process of organic materials in the wastewater by microbes inside the microbial fuel cell reactor. Another Korean patent number 10-2010-0137766 (Dec. 31, 2010) publishes a microbial fuel cell of indirectly oxidizing organics in the sediments using microorganisms by installing negative electrode in the sediments in the lower floor of the lake and positive electrode on the surface of the lake, and reducing the Greenhouse effect accordingly. However, there has been no technology known yet about how to remove heavy metals or to recover precious metals using microbial fuel cell.

While there is a disadvantage in the above-mentioned method of heavy metal removal that comes with high treatment cost as well as post-processing hazardous by-products, microbial fuel cell has an advantage of generating power as well as removing heavy metals or recovering precious metals using organic wastes. It can remove organics from organic wastewater naturally. In addition, as the electrochemical method has a capability to remove heavy metal ion down to a very low level (ppb level) in the contaminated water without any secondary contamination, it is a new sustainable method development to be noticed. Microbial fuel cell technology is hopeful and new as well as helpful to both wastewater treatment and power generation (Cheng, S. A., Dempsey, B. A., Logan, B. E., Environ Sci Technol. 2007, 4, 8149).

### DETAILED EXPLANATION OF INVENTION

### Technological Objective

The purpose of present invention is to provide a method of removing heavy metals or recovering precious metals economically from the wastewater containing such metals without by-products while it is generating power at the same time using microbial fuel cell (MFC) considering such high cost and by-product issues that past method of heavy metal treatment such as mercury from wastewater.

### Technical Solution

In order to achieve our above-mentioned objective, present invention is to provide a method to remove heavy metals from wastewater containing heavy metals or recover precious metals containing precious metals and to generate power at the same time using microbial fuel cells (MFC) with anode, cathode, and the membrane between the two chambers.

In the method of present invention, the heavy metals to remove are Hg²⁺, Hg⁺, Cr⁶⁺, Cr⁵⁺, Cr⁴⁺, Cr³⁺, Cr²⁺, As⁵⁺, As³⁺, Co²⁺, Co³⁺, Cu²⁺, Cu⁺, U⁶⁺, Mn⁷⁺, Mo⁶⁺, Cd²⁺, and Pb²⁺ and the precious metals to recover are Ag⁺, Au²⁺, Au⁺, Pd⁴⁺, Pd²⁺, Pt⁴⁺, Rh²⁺, Ir³⁺, Re³⁺.

Also, anaerobic microbes that are applicable to the microbial fuel cell (MFC) are as follows; Alpha-proteobacteria, Beta-proteobacteria, Delta-proteobacteria, Clostridia, Shewanella oneidensis MR-1, Shewanella oneidensis DSP-10, Shewanella putrefaciens SR-21, IR-1, MR-1, Geobacter sulfurreducens, sulfurreducens KN400, Ochrobactrum anthropi YZ-1, Brevibacillus sp. PTH1, E. coli K12 HB101, Aeromonas hydrophila, Corynebacterium sp. MFC03, Leptothrix discophora SP-6, Bacillus licheniformis, Bacillus thermoglucosidasius, Spirulina platensis, Bacillus subtilis, Enterococcus gallinarum, Acetobacter aceti, Gluconobacter roseus.

In the microbial fuel cell (MFC) of present invention, both anode and cathode consist of carbon materials such as carbon felt, carbon clothing, carbon rod, carbon paper, carbon brush, and the membrane between the electrodes consists of cation exchange membrane (CEM), composite membrane, nylon membrane, anion exchange membrane (AEM), and there can be more than two microbial fuel cells installed as well.

Although single MFC can remove or recover heavy metals directly in case voltage is sufficient, if sufficient voltage is not available from continuous configuration of MFC, it is possible to remove metal ions simultaneously from both ends using the voltage from the shear of MFC that can be applied to the rear end of MFC. The configuration of multiple MFCs using more than two MFCs can remove or recover different kinds of ions from the rear end, even if the kind of ion to remove in the shear end is not the same kind of ion with different valence, in case of a single MFC due to its lack of voltage together with the additional voltage from the shear of even if the ions to be removed are different kinds of metals.

Present invention provides a method to remove Hg²⁺ as metal Hg, or solid sediment or precipitate Hg₂Cl₂, generating power simultaneously from mercury-containing wastewater especially. In this case, it is desirable that mercury-containing wastewater should be adjusted with its initial pH as 2 to 4.8, and its initial Hg²⁺ concentration as 25 to 100 mg/L, and it is more desirable to adjust its initial pH using diluted hydrochloric acid.

Present invention is to remove heavy metals or recover precious metals as solid sediment or precipitate from wastewater generating power simultaneously using MFC technology, and to explain its functioning principle in the following with an example of a method to remove Hg²⁺ as metal Hg or solid sediment or precipitate Hg₂Cl₂.

In a general two chamber (anode and cathode) MFC, the electrons that are generated from the biodegradation of organics in anode move towards cathode through external circuit to react with electron acceptors in order to produce electric current. Meanwhile ions and protons move through the membrane between two electrode chambers in order to achieve charge neutrality (Kim, J. R., Cheng, S. A., Oh, S. E., Logan, B. E., Environ. Sci. Technol. 2007, 41, 1004). In order to use material as electron acceptors in MFC, the electrical potential of cathode should be higher than the electrical potential of NAD⁺/NADH in the microbes in the anode to produce positive electromotive force (emf) between anode and cathode. According to the published results, the higher the standard electrical potential of electron acceptors are, the more the power production inside MFC improves. (Li, Z. J., Zhang, X. W., Lei, L. C., Proc. Biochem. 2008, 43, 1352).

Hg²⁺ is also an electron acceptor that can be used as MFC (in case it is used as an electron acceptor) due to its high electrical potential. Electrochemical equation and its hydrogen standard electrical potential at 25° C. is as follows:

2Hg²⁺(aq)+2e⁻=Hg₂²⁺(aq)E⁰=0.911 V (1)

Hg₂²⁺(aq)+2e⁻=2Hg(l)E⁰=0.796 V (2)

In the presence of Cl⁻, Hg₂²⁺ can be precipitated by the following chemical reaction, and its reaction will compete with reaction (2).

Hg₂²+2Cl⁻=Hg₂Cl₂(s) (3)

In case we use acetate as an electron donor, the reduction potential of HCO₃⁻/CH₃COO⁻ at pH 7 is as follows:

HCO₃⁻+8H++CO₂+8e=CH₃COO⁻+3H₂OE⁰=−0.284V (4)

If Hg²⁺ is used as an electron acceptor, and acetate is used as an electron donor, we can get electric current of 1.195 V theoretically according to reaction (1) and reaction (4). As in the above discussion, toxic Hg²⁺ can be removed from the solution theoretically by reduction as an electron acceptor of MFC because the reduction potential is higher than the acetate ion's electrical potential (E⁰=−0.284 V at pH 7).

In addition to Hg²⁺, the reduction electrical potential of metals that present invention can remove is as follows:

Cr₂O₇²⁻(aq)+14H⁺+6e⁻=2Cr³⁺+7H₂OE^{o}=1.29 V

Cr⁵⁺(aq)+e⁻=Cr⁴⁺E^{o}=1.34 V

Cr⁴⁺(aq)+e⁻=Cr³⁺E^{o}=2.10 V

Cr³⁺(aq)+e⁻=Cr²⁺E^{o}=−0.424 V(2MFCs required)

Cr²⁺(aq)+2e⁻=Cr(s)E^{o}=−0.79 V(2MFCs required)

H₃AsO₄(aq)+2H⁺+2e⁻=HAsO₂(aq)+2H₂OE^{o}=0.559 V

AsO₂⁻(aq)+2H₂O+3e⁻=As(α)+40H-E^{o}=−0.68 V(2MFCs required)

Co³⁺(aq)+e⁻=Co²⁺E^{o}=1.95 V

Co²⁺(aq)+2e⁻=Co(s)E^{o}=−0.287 V(2MFCs required)

Cu²⁺(aq)+2e⁻=Cu(s)E^{o}=0.337 V

Cu⁺(aq)+e⁻=Cu(s)E^{o}=0.521 V

UO₂²⁺(aq)+4H⁺+2e⁻=U⁴⁺+2H₂OE^{o}=0.269 V

U⁴⁺+4OH⁻=U(OH)₄(s)

MnO₄⁻(aq)+4H⁺+3e⁻=MnO₂(s)+2H₂OE^{o}=1.69 V

MnO₄⁻(aq)+2H₂O+3e⁻=MnO₂(s)+4OH⁻E^{o}=0.596 V

MnO₄²⁻(aq)+4H⁺+2e⁻=MoO₂(s)+2H₂OE^{o}=0.606 V

Pb²⁺(aq)+2e⁻=Pb(s)E^{o}=−0.126 V

Cd²⁺(aq)+2e⁻=Cd(s)E^{o}=−0.403 V(2MFCs required)

Also, the reduction potentials of the metals to be recovered according to the present invention are as follows:

[Ag(NH₃)₂]−(aq)+e⁻=Ag(s)+2NH₃ E^{o}=0.373 V

Ag²⁺(aq)+e⁻=Ag⁺E^{o}=1.980 V

Ag⁺(aq)+e⁻=Ag(s)E^{o}=0.799 V

AuI₂⁻+e⁻=Au(s)+2I⁻E^{o}=0.578 V

[Au(SCN)₂]⁻+e⁻=Au(s)+2SCN⁻E^{o}=0.689 V

[AuCl₂]⁻+e⁻=Au(s)+2Cl⁻E^{o}=1.154 V

Au³⁺+3e⁻=Au(s)E^{o}=1.50 V

Au⁺+e⁻=Au(s)E^{o}=1.68 V

PdCl₆²⁻(aq)+2e⁻=PdCl₄²⁻(aq)+2Cl⁻E^{o}=1.29 V

PdCl₄²⁻(aq)+2e⁻=Pd(s)+4Cl⁻E^{o}=0.59 V

Pd²⁺+2e⁻=Pd(s)E^{o}=0.915 V

[PtCl₄]²⁻+2e⁻=Pt(s)+4Cl⁻E^{o}=0.847 V

[PtCl₆]²⁻+2e⁻=[PtCl₄]²⁻(aq)+2Cl⁻E^{o}=1.011 V

Pt²⁺+2e⁻=Pt(s)E^{o}=1.320 V

Rh³⁺+3e⁻=Rh(s)E^{o}=0.758 V

Ir₂O₃(s)+3H₂O+6e⁻=2Ir(s)+6OH⁻E^{o}=0.098 V

IrCl₆³⁻+3e⁻=Ir(s)+6Cl⁻E^{o}=0.86 V

Ir³⁻+3e⁻=Ir(s)E^{o}=1.16 V

ReO₂(s)+4H⁺+4e⁻=Re(s)+2H₂OE^{o}=0.260 V

Re³⁺+3e⁻=Re(s)E^{o}=0.300 V

ReO⁴⁻+4H⁺+3e⁻=ReO₂(s)+2H₂OE^{o}=0.510 V

ReO⁴⁻+2H⁺+e⁻=ReO₂(s)+H₂OE^{o}=0.768 V

FIG. 1 is a schematic diagram to show the removal of heavy metals or recovery of precious metals mechanisms having more positive potentials than the reduction potential of organic material. It is possible indirectly to remove or recover the metal ions which have different oxidation numbers with no positive potential by supplying a power source with a cell arrangement with the same or different metal ions with more positive potential in the cathode chamber.

### Effect of Invention

According to present invention, removal of heavy metals or recovery of precious metals from wastewater can be conducted at the same time with the production of power using MFC technology. Especially Hg²⁺ can be removed as metal Hg or solid precipitates or sediments of Hg₂Cl₂ effectively, and additionally, chrome and arsenic (As) ion can be removed as well. Also silver, gold, palladium, platinum, rhodium, iridium and rhenium ion can be recovered with high efficiency. Specially, a two-chamber MFC can remove or recover many kinds of ions by applying the voltage of shear end MFC to the rear end MFC if the rear end MFC's voltage is not enough.

### BRIEF EXPLANATION OF FIGURES

FIG. 1 is a schematic diagram to show a mechanism of removal of heavy metals or recovery of precious metals with higher positive reduction potential than the reduction potential in the organics.

FIG. 2 is a schematic diagram of MFC for Hg²⁺ removal according to present invention.

FIG. 3 is a graph of the concentration of the emitted Hg at various initial pH in the MFC of present invention.

FIGS. 4 and 5 are graphs of the concentration of the emitted Hg at various initial concentrations of Hg²⁺ (FIG. 4), and maximum power density (FIG. 5) in the MFC of present invention.

FIG. 6 is a graph to show the maximum power density as a function of current concentration in the MFC of present invention.

FIG. 7 is a schematic diagram to show the two-chamber MFC installation to remove Cr⁶⁺ and Cr³⁺.

FIG. 8 to 12 are schematic diagrams to show the removal process of Cr³⁺ in the form of solids as a voltage curve as a function of time in the MFC of present invention.

FIGS. 13 and 14 are graphs to show the removal efficiency of Cr³⁺ and the concentration of the remaining Cr³⁺ at each initial concentration of 50 ppm and 100 ppm.

FIG. 15 is a schematic diagram to show the two-chamber MFC installation to remove As⁵⁺ and As³⁺.

FIGS. 16 to 20 are graphs to show the removal process of As³⁺ as a current curve as a function of time in the two-chamber MFC of present invention.

FIG. 21 is a graph to show the removal efficiency of As³⁺ and the concentration of remaining As³⁺ at the initial concentration of As³⁺ of 50 ppm.

FIG. 22 is a graph to show the removal efficiency of As³⁺ and the concentration of remaining As³⁺ at the initial concentration of As³⁺ of 100 ppm.

FIG. 23 is a graph to show the change of voltage as a function of time at various concentration of Ag⁺ (25, 50, 100, 200 ppm) in the MFC of present invention.

FIG. 24 is a graph to show the recovery rate of Ag as a function of time at various initial concentration of Ag⁺ (25, 50, 100, 200 ppm).

FIG. 25 is a graph to show the recovery rate of Au as a function of time at various initial concentration of Au³⁺ (25, 50, 100, 200 ppm) using MFC of present invention.

FIG. 26 is a graph to show the recovery rate of Pd as a function of time at various initial concentration of Pd²⁺ (25, 50, 100, 200 ppm) using MFC of present invention.

FIG. 27 is a graph to show the recovery rate of Pt as a function of time at various initial concentration of Pt⁴⁺ (25, 50, 100, 200 ppm) using MFC of present invention.

FIG. 28 is a graph to show the recovery rate of Rh as a function of time at various initial concentration of Rh³⁺ (25, 50, 100, 200 ppm) using MFC of present invention.

FIG. 29 is a graph to show the recovery rate of Ir as a function of time at various initial concentration of Ir³⁺ (25, 50, 100, 200 ppm) using MFC of present invention.

FIG. 30 is a graph to show the recovery rate of Re as a function of time at various initial concentration of Re³⁺ (25, 50, 100, 200 ppm) using MFC of present invention.

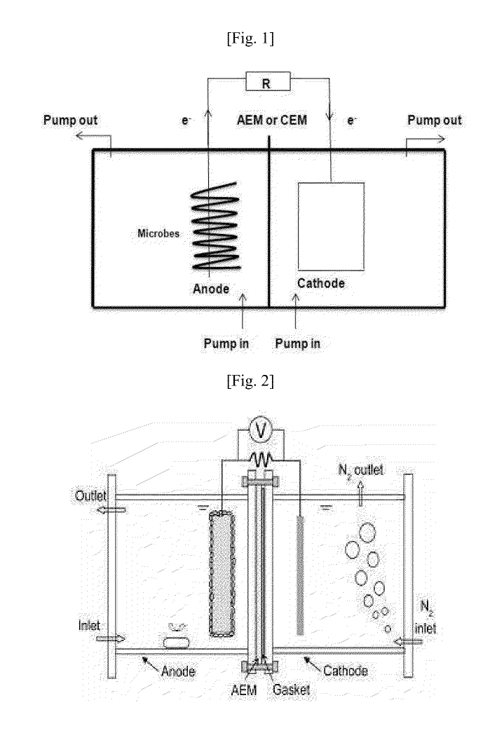

### BEST MODE FOR EMBODIMENT OF THE INVENTION

In the following, present invention is explained more concretely through an embodiment. The following is an embodiment of removal of mercury, chrome, and arsenic among the heavy metals in the wastewater, and an embodiment of recovery of silver, gold, palladium, platinum, rhodium, iridium, and rhenium. These are only examples of present invention, and the scope of present invention is not limited by these examples.

### Embodiment 1

### Removal of Mercury from Wastewater

Removal of Hg²⁺ ion from mercuric wastewater (MWW) was conducted using MFC technology, and the influential factors to the removal efficiency of Hg²⁺ such as the initial concentration of Hg²⁺ and initial pH were observed.

MFC was configured in such a way that anode (oxide electrode, positive electrode) was made of carbon felt, and cathode (reduction electrode, negative electrode) was made of carbon paper, and the membrane between two electrode chambers was made of anion exchange membrane.

(1) Installation of MFC

Present invention used a two-chamber MFC that has the volume of 137 ml (length: 7 cm, diameter: 5 cm) of each electrode chamber of plexiglass. Valid capacity of both was 120 ml for each. Electrode chamber was divided by anion exchange membrane (AEM, AMI-7001, Membrane International Inc., USA) with a surface of 19.6 cm² (diameter=5 cm). AEM was pre-treated by dipping in NaCl solution and washed by distilled water before its use. (Kim, J. R., Cheng, S. A., Oh, S. E., Logan, B. E., Environ. Sci. Technol. 2007, 41, 1004).

As anode, carbon felt with a surface of 35.6 cm² (3.5 cm×3 cm, 1.12 cm thick, Alfa Aesar, USA) was chosen, and as cathode, carbon paper with a surface of 21 cm² (3 cm×3.5 cm) was used.

As reported by Wang et al. (Wang, X., Cheng, S. A., Feng, Y. J., Merrill, M. D., Saito, T., Logan, B. E., Environ. Sci. Technol. 2009, 43, 6870), both anode and cathode were pre-treated by dipping in acetone for 24 hours, washed by distilled water, and heated in a muffle furnace for 30 minutes at 450° C. In order to collect power, it was connected by titanium line, and covered by Carbon-epoxy on its contact point, and connected after heating for about 2 hours at 200° C. External resistance of 500Ω was connected if there is no other special comment.

Hg²⁺ was not expected to move directly because AEM Membrane was used, and the inflow of lethal material to the growth of microbes could be prevented. As a result of ICP analysis in fact, the concentration of Hg²⁺ was not detected from the solution of anode chamber. Protons seemed to be the same situation as Hg²⁺. In present invention, pH was well adjusted to the batch operation using phosphate-buffered saline.

FIG. 2 is a schematic diagram of MFC for removal of Hg²⁺ according to present invention.

(2) Inoculation

Anaerobically inoculated microbes were collected in the wastewater treatment facility of Okcheon county. The mixed solution of 90 ml artificial wastewater (AW) and 30 ml sludge was infused with Nitrogen gas to remove dissolved oxygen, and was pumped into the anode chamber. 1 l of AW contains the following: as electron donor, 1.36 g CH₃COONaH₂), 1.05 g NH₄Cl, 1.5 g KH₂PO₄, 2.2 g K₂ HPO₄, and 0.2 g Yeast extract.

Whenever the voltage fell down below 25 mV in each cycle, electron donor of 0.2 g was supplemented to anode chamber. Anode chamber was continuously stirred by a magnetic stirrer. Cathode chamber was filled with 120 ml distilled water, and air was infused to use the dissolved oxygen as an electron acceptor.

The Anaerobic microbe that is used for the MFC of present invention is as follows; Alpha-proteobacteria, Beta-proteobacteria, Delta-proteobacteria, Clostridia, Shewanella oneidensis MR-1, Shewanella oneidensis DSP-10, Shewanella putrefaciens SR-21, IR-1, MR-1, Geobacter sulfurreducens, Geobacter sulfurreducens KN400, Ochrobactrum anthropic YZ-1, Brevibacillus sp. PTH1, E. coli K12 HB101, Aeromonas hydrophila, Corynebacterium sp. MFC03, Leptothrix discophora SP-6, Bacillus licheniformis, Bacillus thermoglucosidasius, Spirulina platensis, Bacillus subtilis, Enterococcus gallinarum, Acetobacter aceti, Gluconobacter roseus.

(3) Operation

After successfully starting MFC, artificial wastewater (AW) was replaced with new AW. Cathode chamber was refilled with MWW (Mercury Wastewater). MWW was made by dissolving HgCl² into distilled water and making a main solution of 200 mg/L Hg²⁺, and deluting with distilled water as needed. Diluted hydrochloric acid was used in order to adjust pH (Yardim, M. F., Budinova, T., Ekinci, E., Petrov, N., Razvigorova, M., Minkova, V., Chemosphere 2003, 52, 835). The existence of Cl⁻ ion was expected to be helpful in removing mercury ion with Hg²Cl². Cathode chamber was infused with N₂ gas (60 mΩ/min) in order to prevent dissolved oxygen from consuming power and to blend solutions during the experimentation.

pH in Hg²⁺ removal and initial Hg²⁺ concentration effect was evaluated in batch status. To accomplish the maximum power density, cathode chamber was changed from batch status to continuous status to maintain a certain level of Hg²⁺ from MWW storage while N₂ gas was infused. In addition, external resistance was changed from 4000Ω to 50Ω. All experimentation was performed inside a temperature-controlled incubator at 30° C.

(4) Calculation and Analysis

Voltage(V) was measured by constant-voltage device (WMPG 1000, Won-A Tech, Korea or LabView, USA) every minute. Power density was calculated according to P=V²/RA. Here R is external resistance, A is a surface of anode. Coulombic efficiency (CE) was calculated according to the following equation.

$$CE = 8 {\int }_{0}^{t} I d t / {Fv}^{Δ} COD$$

Here, 8 is always used for the number of electrons 4 and COD whose electronic exchange of oxygen per mole, M_{O2}=32 that is molecular weight of O². I is electric current that was calculated by I=V/R, t is Time gap, F is Faraday constant (96485 C./mol e⁻), v is effective volume of anode, ^{Δ}COD is change of consumption of oxygen demand.

Internal resistance was decided as the slope of the linear portion of I-V Curve. In 1 or 2 hours of sampling interval, 1 ml solution was sampled from N₂ outlet in order to analyze total mercury using ICP Light Emitting Spectra method (ICPE-9000, Shimadzu, Japan). The sediment on the floor of cathode was collected by being filtered with glass micro-fiber filter. Chemical form of sediment was identified with EDS (Quantax 200, Bruke, Germany).

(5) Result

\textcircled{1} pH effect

Low pH at its initial status was led to high concentrations of mercury emissions. Adjustment of pH from 4.8 to 2 increased the ionic conductivity from 13.2 μs/cm to 5160 μs/cm, which could increase power reduction reaction rate (Reaction Equation (1)). Meanwhile, as compared with high pH, low pH is induced by the high solubility (Kₛₚ=3.5×10⁻¹⁸ at 25° C.) of Hg₂Cl₂, although Hg₂²⁺ ion is reduced into more metal Hg according to the Reaction equation (2), it could increase the concentration of Hg₂²⁺ ion in the solution. Therefore, total concentration of mercury emission at low pH was higher than that at high pH. As reaction proceeded, most Hg₂₊ were reduced into metal mercury at low pH and was removed in the form of Hg₂Cl₂ at high pH.

As a result of EDS analysis of sediment on the anode surface and anode chamber floor, while only mercury was detected on the surface of anode, both mercury and chlorine was detected from the floor sediment of anode chamber. This shows that Hg²⁺ can be completely reduced to Hg according to the reaction equation (1) and (2). Also, the sediment of Hg₂Cl₂ was proved from the solution of anode chamber.

In the 5 hour reaction, emissions of Hg²⁺ concentrations were 2.08±0.07, 4.21±0.340.00 and 5.25±0.36 mg/L at pH 2, 3, 4 and 4.8. In the 10 hour reaction, emissions of Hg²⁺ concentrations were 0.44˜0.69 mg/L, which shows the removal efficiency of 98.22˜99.54%. This kind of removal efficiency of Hg²⁺ was similar to the value that was reported in the conventional technology. However, power generation, no need for exchange of adsorbent such as activated carbon, microbial functional treatment in the wastewater as an electron donor enable MFC a hopeful and sustainable technology as compared with other technology. (Hutchison, A., Atwood, D., Santilliann-Jiminez, Q. E., 2008, J. Hazard Mater., 156, 458).

Next table 1 is a comparison of Hg²⁺ removal efficiency of present invention with conventional method.

TABLE 1

| | Initial | Removal | |
|---|---|---|---|
| | Concentration | Efficiency | |
| Method | (mg/L) | (%) | Reference |
| Ion Exchange | 90 | 99.96 | Monteagudo and |
| | | | Ortiz, 2000 |
| 2 - bots Cap Toe | 50 | >99 | Manohar et al., |
| benzimidazole clay | | | 2002 |
| Adsorption | | | |
| Modified TiO2 | 150 | >99 | Skubal and |
| arginine by | | | Meshkov, 2002 |
| photocatalytic | | | |
| removal | | | |
| Precipitation on the | 30 | 92.83-100 | Hutchison et al, |
| Multiple sulfur- | | | 2008 |
| containing open- | | | |
| chain ligands | | | |
| Activated Carbon | 40 | 96.29-99.7 | Rao et al, 2009 |
| Adsorption | | | |
| Microbial Fuel Cell | 25-100 | 98.22-99.54 | Present invention |

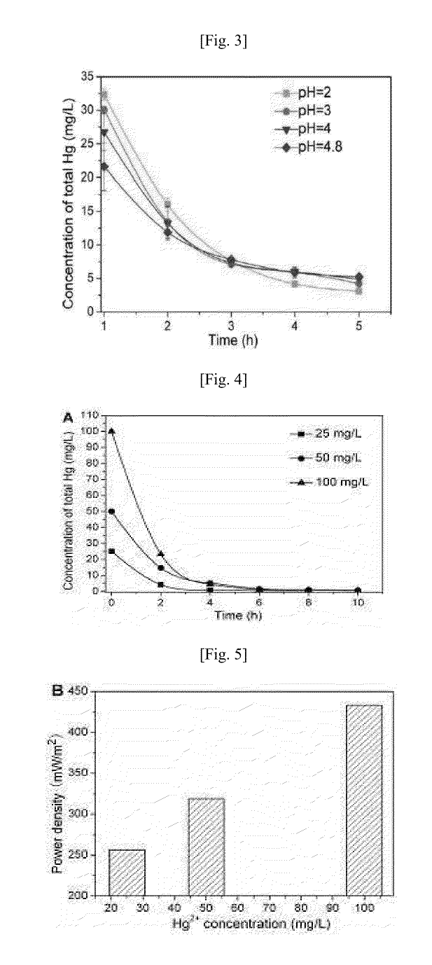

FIG. 3 is a graph to show the concentration of Hg emissions at various initial pHs in the MFC of present invention (50 mg/L Hg₂₊, average±SD, n=2).

Maximum power density increased from 8.9 mW/m² to 318.7 mW/m² when pH was adjusted from 4.8 to 2. Because protons are not needed in the reduction of Hg²⁺ or Hg₂²⁺ according to the reaction equation (1) and (2), power production increase should be due to the decrease of internal resistance of MFC from 3816.6Ω to 126.7Ω according to the decrease of pH from 4.8 to 2. This kind of change of internal resistance was due to the ionic conductivity increase from 13.2 μs/cm to 5160 μs/cm when the initial pH was adjusted from 4.8 to 2. This is because proton-ion was different from other kinds of electron acceptors such as permanganate ion that accompanied the reduction of electron acceptors. (You, S. J., Zhao, Q. L., Zhang, J. N., Jiang, J. Q., Shao, S. Q., J. Power Sources 2006, 162, 1409).

\textcircled{2} Initial Hg²⁺ Effect

At the fixed pH of pH 2, the concentration profile of total Hg²⁺ emissions at various initial Hg²⁺ concentration such as 25 or 100 mg/L was investigated. FIGS. 4 and 5 are graphs to show the concentration of Hg emissions at various initial Hg²⁺ concentration (FIG. 4) and Maximum power density (FIG. 5) (pH 2, External resistance of 4000Ω to 50Ω) according to present invention.

As shown here, the emission concentration of Hg²⁺ decreased rapidly for first 2 hours and gradually slowed down within 6 hours. The reduction speed of Hg²⁺ increased with the increasing initial concentration of Hg²⁺. After 6 hours of reaction, the concentration of Hg²⁺ emission did not change much as compared with the concentration of different Hg²⁺. After 10 hours of reaction, the concentration of Hg²⁺ emissions was in the range of 0.44 mg/L˜0.69 mg/L over the concentration of 25 mg/L˜100 mg/L Hg²⁺.

When the concentration of Hg2+ increased from 25 mg/L to 100 mg/L, the maximum power density rose from 256.2 mW/m² to 433.1 mW/m². The concentration effect of initial Hg²⁺ was found to be similar to other kinds of electron acceptors that were reported by other research groups. (Li, Z. J., Zhang, X. W., Lei, L. C., Proc. Biochem. 2008, 43, 1352).

The high concentration of electron acceptors raises the reduction potential and further increases the open-circuit voltage and power production. The high concentration of the electron acceptor reduces the internal resistance of the battery (Li, Z. J., Zhang, X. W., Lei, L. C., Proc. Biochem. 2008, 43, 1352). When the concentration of Hg²⁺ was increased from 25 mg/L to 100 mg/L under the constant oxidation potential, the reduction potential of MFC rose from 275.0 mV to 454.4 mV, and the voltage of open-circuit rose from 663.8 mV to 845.1 mV. At the same time, the ionic conductivity rose from 4.96 ms/cm to 5.46 ms/cm. Consequently internal resistance decreased from 146.9Ω to 107.9Ω. CE was calculated within the range of 1.55˜4.04% over various other Hg²⁺ concentrations. Probably low CE was due to the dissolved oxygen that was not removed using N² before pumping electrodes chamber while the dissolved oxygen in the solution medium consumed the precipitated organic matter during the short discharge period.

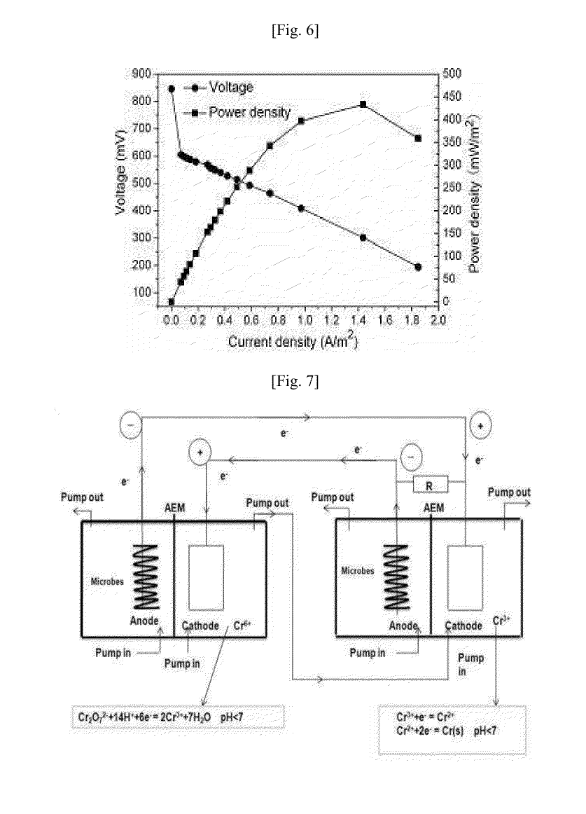

FIG. 6 is a graph to show the maximum power density as a function of current concentration and voltage (100 mg/L Hg²⁺, pH 2, external resistance of 4000Ω˜50Ω). When external resistance was 100Ω in the current concentration of 1.44 A/m², maximum power density was determined as 433.1 mW/m² from the power curve. Internal resistance of 107.9Ω (R2=0.998) is a value from the slope of voltage over current. Theoretically maximum power density should be from internal resistance value. Two values were close to each other and both methods were reliable within the tolerance range. MFC with Hg²⁺ reduction was 1.5 times higher than Cu²⁺ regardless of any other reduction material that was used. (433.1 mW/m² over 280 mW/m²) (Wang, Z. J., Lim, B. S., Lu, H., Fan, J., Choi, C. S., Bull. Korean Chem. Soc. 2010, 7, 2025) If Hg²⁺ is used as electron acceptor, it does not seem to be appropriate due to its toxicity. In the current embodiment, our purpose is to remove Hg²⁺ from the wastewater and power generation becomes available as a by-product.

As seen in the above result, in the MFC of present invention, initial pH had an impact on the removal efficiency of Hg²⁺ from electrochemical and chemical reactions. After 5 hours of reaction, concentration of Hg²⁺ emissions showed 3.08±0.07, 4.21±0.34, 4.84±0.00 and 5.25±0.36 mg/L at pH 2, 3, 4 and 4.8. After 10 hours of reaction, the concentration of Hg2+ emissions was in the range of 0.44˜0.69 mg/L at various Hg²⁺ initial concentrations (25, 50, and 100 mg/L). The initial pH and the Hg²⁺ concentration had an impact on the power production. The pH in the lower side and the Hg²⁺ concentration in the higher side resulted in higher maximum power density. The maximum power density of 433.1 mW/m² was reached at 100 mg/L Hg²⁺ and pH 2.

### Embodiment 2

### Removal of Cr⁶⁺/Cr³⁺ from Wastewater Containing them

FIG. 7 is a schematic diagram to show a two-chamber MFC for the removal of Cr⁶⁺ and Cr³⁺. This kind of two-chamber MFC is used in the removal or recovery by applying a shear voltage downstream to the rear end in case the rear MFC's voltage is not sufficient. This method enables the removal or recovery of many kinds of ions.

In the current embodiment, cathode chamber's condition is shown in the table 2.

TABLE 2

| | Number 1 Cathode | Number 2 Cathode |
|---|---|---|
| | chamber | chamber |
| Ion | Cr⁶⁺ | Cr³⁺ |
| Material | Carbon brush | Carbon cloth |
| | 2.5 × 2.5 cm | 1.7 × 1.3 cm |
| Volume | 100 ml | 100 ml |
| Ion Concentration | 200 ppm | 100 ppm |
| Membrane | CEM | AEM |
| pH Value | 2 | Not adjusted, 6.4 |
| K₂SO₄ Concentration | 200 mM | 200 mM |
| Exchange Method | Removal of N₂ | Removal of N₂ |

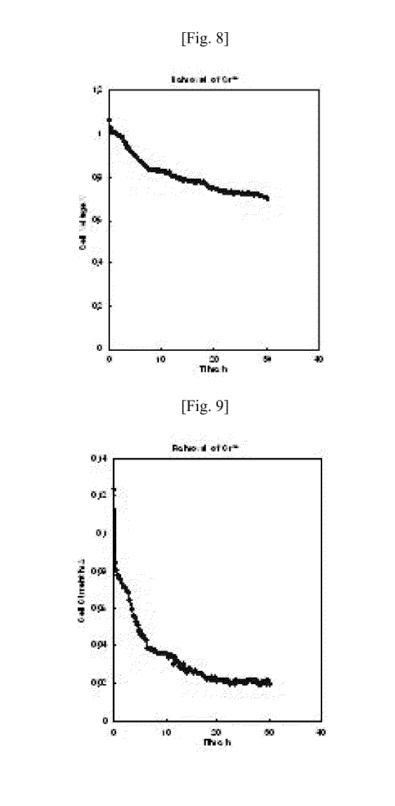

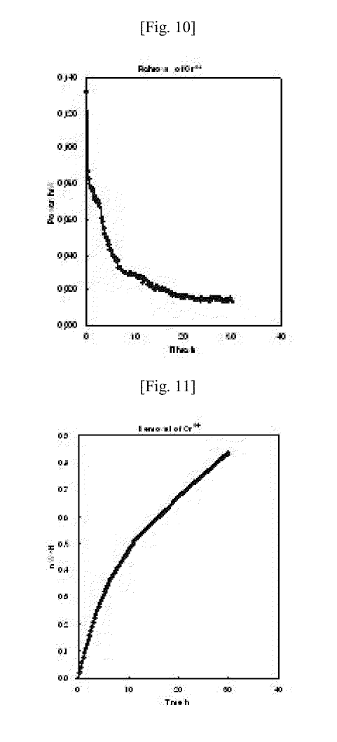

FIG. 8˜12 are graphs to show the removal process of Cr³⁺ in the form of solids as the voltage curve as a function of time in the two-chamber MFC of present invention. The initial concentration is 100 ppm. In other words, by generating power from microbial fuel cell that consists of acetate-organic-containing wastewater in the shear end and Cr⁶⁺-containing wastewater in the shear end and applying directly to the rear end microbial fuel cell without external resistance, it shows the voltage curve as a function of time to show the process of removal in the form of Cr³⁺.

Examining these voltage curves in detail, there is a voltage loss of 0.55 V from the shear end fuel cell power because it is an adsorption energy process to remove Cr³⁺ in the form of metal Cr in the rear end fuel cell. The voltage from the shear fuel cell falls to around 0.7 V in about 30 minutes. It seems to be due to the high concentration overvoltage from the removal of Cr³⁺ in the rear end. Blue color solid sediment was visually observed and could be separated by a laboratory filter paper in the cathode chamber of the rear end that is the side of removing Cr³⁺. As seen in the current vs. time curve, the current falls down to the lowest in about 20 hours and Cr³⁺ is almost completely removed.

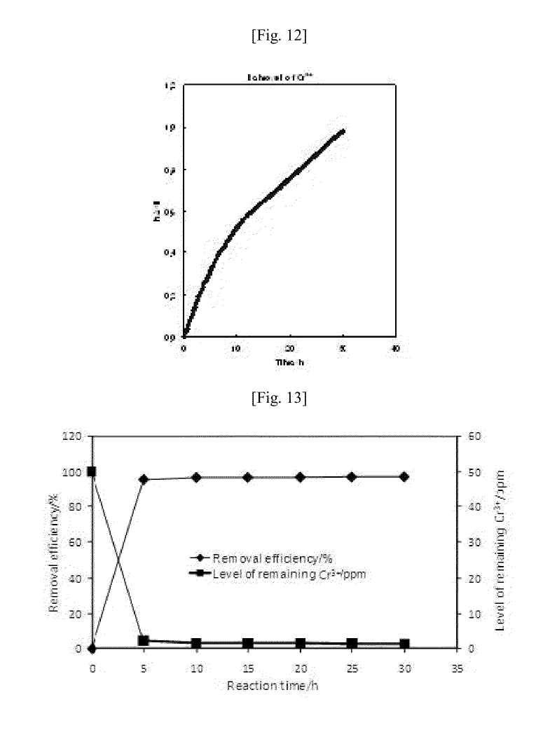

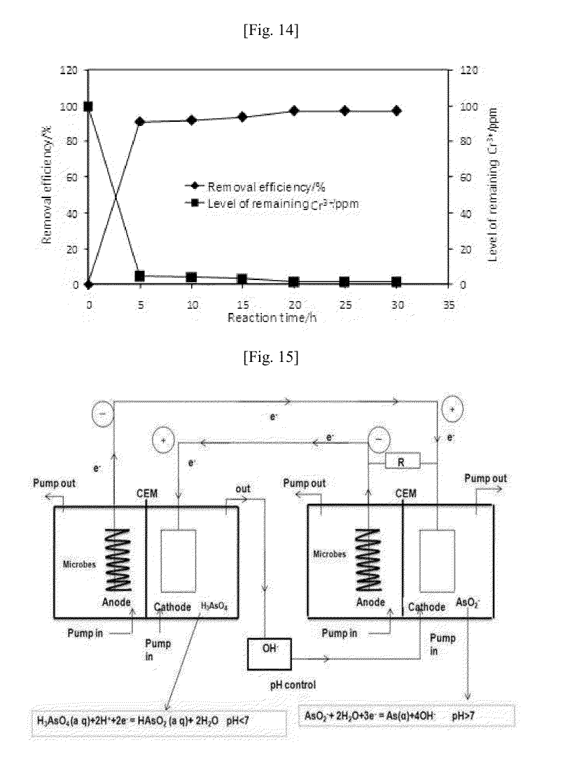

FIGS. 13 and 14 are graphs to show the removal efficiency and the remaining concentration of Cr³⁺ at the initial concentration of 50 ppm and 100 ppm. We examined that after 30 hours of treatment both the removal efficiency of Cr³⁺ and the remaining level of Cr³⁺ were 97.26% and 1.37 ppm either in 50 ppm or 100 ppm of the initial concentrations of Cr³⁺ commonly. Also, Cr⁶⁺ was more easily removed with a removal efficiency of over 99% than Cr³⁺.

### Embodiment 3

### Removal of As⁵⁺/As³⁺ from Wastewater

FIG. 15 is a schematic diagram to show a two-chamber MFC installation for the removal of As⁵⁺/As³⁺. This kind of two-chamber MFC is used for removal or recovery to apply voltage of shear end MFC down to rear end if rear end MFC's voltage is not sufficient. This method can remove or recover many different kinds of ions.

The conditions of cathode chamber are shown in the following table 3.

TABLE 3

| | Number 1 Cathode | Number 2 Cathode |
|---|---|---|
| | chamber | chamber |
| Ion | As⁵⁺ | As³⁺ |
| Material | Carbon brush | Carbon cloth |
| | 2.5 * 2.5 cm | 1.7 * 1.3 cm |
| Volume | 100 mL | 100 mL |
| Ion Concentration | 100 ppm | 50 ppm |
| Membrane | CEM | CEM |
| pH | 2 | Unadjusted, 9.5 |
| K₂SO₄ Concentration | 200 mM | 200 mM |
| Stirring method | N₂ removal | N₂ removal |

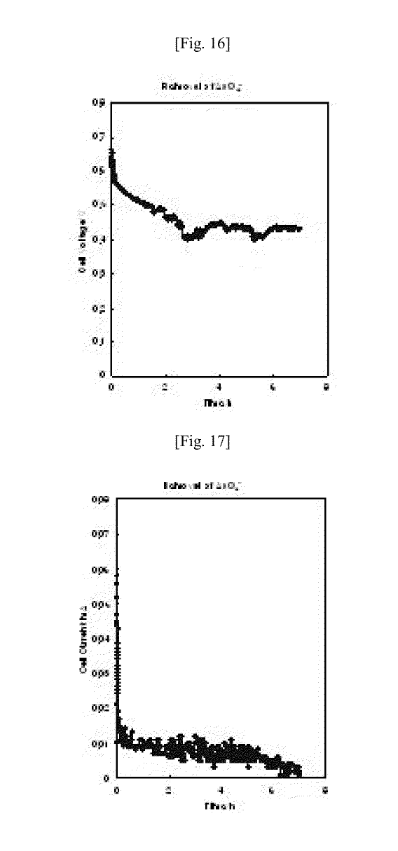

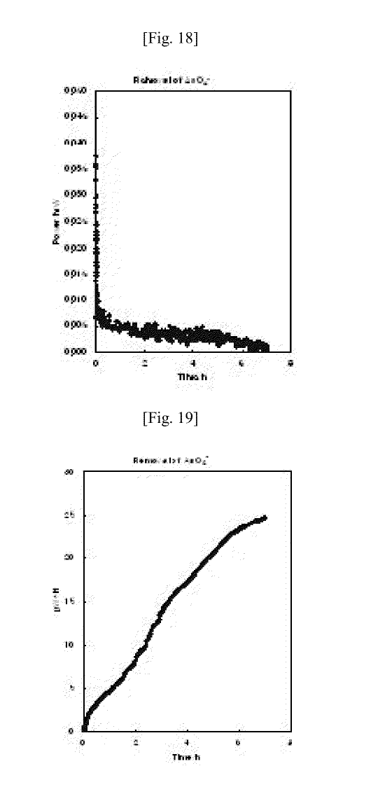

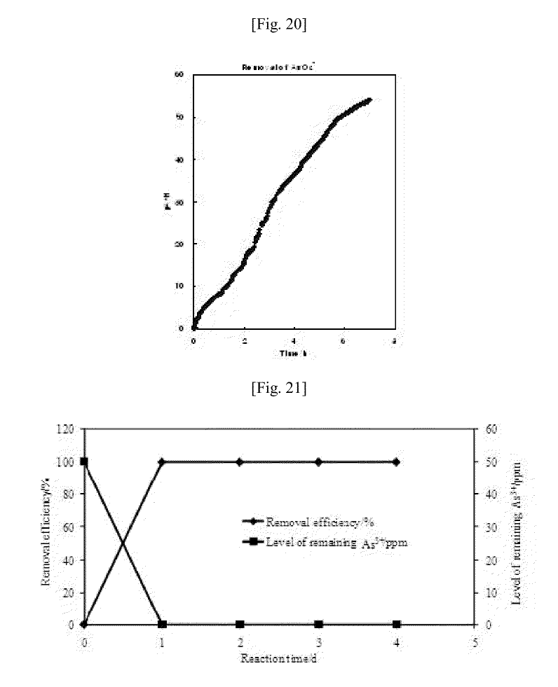

FIGS. 16 to 20 are graphs of showing a two-chamber MFC in accordance with the present invention process to remove AS³⁺ as the curve of the voltage as a function of time. Its initial concentration is 50 ppm. In other words, it shows the course of removing both AS⁵⁺ and AS³⁺ as an electrochemical signal while the energy generated in the reduction process from H₃AsO₄ to HAsO₂ in the shear is supplied to the precipitation process from AsO₂ to As at the rear end. These are the reactions which occur in the cathode chamber, and in the anode chamber there occurs the oxidation of acetate, which is one of the organic wastes. Because the reduction of H₃AsO₄ to HAsO₂ in the acidic solution of the shear end is a two electron reaction and the reduction reaction of HAsO₂ generated in the shear end by way of AsO₂ of basic solution to As is a three electron reaction, the concentration of the same volume of the shear must be at least 1.5 times. The other hand, if you are using a solution of the same concentration, the volume of solution of the shear end should be at least 1.5 times, and can fully reduce the AsO₂ of the rear end strategically. However, in the present embodiment, the concentration was doubled with the volume to be the same. The reaction system was prepared to make the concentration of the shear to be 100 ppm, and that of the rear to be 100 ppm, and 50 ppm. The negative electrode of the shear end was connected to the positive electrode of the rear end, and the positive electrode of the shear end was connected to the negative electrode of the rear end, and the reaction started.

The following Table 4 and 21 are table and graph to show the removal efficiency of As³⁺ at the initial concentration of As³⁺ to be 50 ppm, and the remaining concentration of As³⁺.

TABLE 4

Reaction Time/Day

| | 1 | 2 | 3 | 4 |
|---|---|---|---|---|
| Remaining As³⁺ | 0.04 | 0.03 | 0.02 | 0.01 |
| Concentration | | | | |
| (As³⁺/ppm) | | | | |
| Removal | 99.92 | 99.94 | 99.96 | 99.98 |
| Efficiency % | | | | |

As shown in Table 4 and also at FIG. 21, as a result of ICP-AES analysis after reaction for approximately 1 day, the concentration of AsO₂ in the cathode reactor fell down to 0.04 ppm from 50 ppm, showing the removal rate of 99.92%. After 4 days, the level of AS³⁺ was 0.01 ppm, and the removal rate was 99.98%.

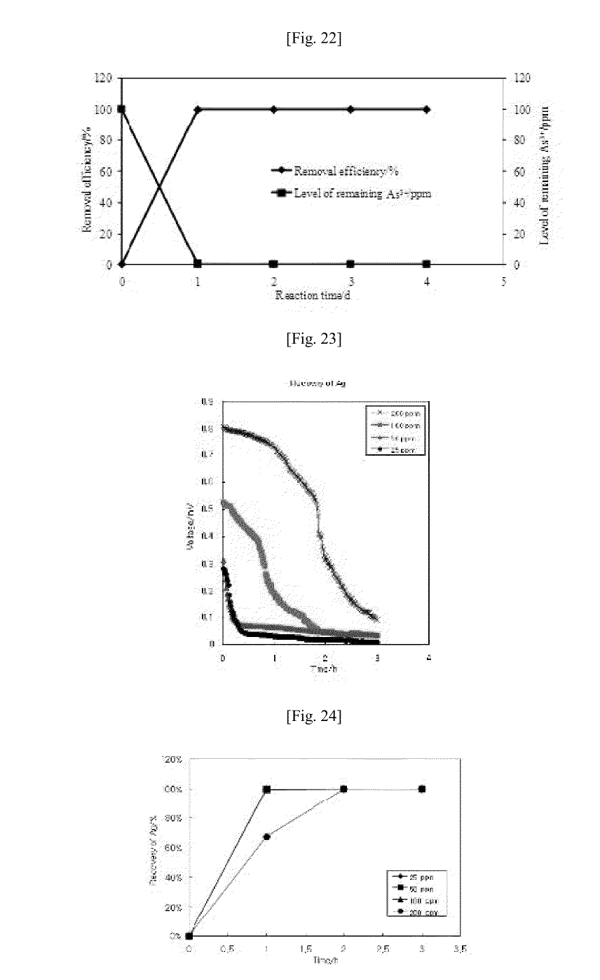

The following Table 5 and FIG. 22 are table and graph to show the removal efficiency of As³⁺ at the initial concentration of As³⁺ 100 ppm, and the remaining As³⁺ concentration.

TABLE 5

Reaction Time/ Day

| | 1 | 2 | 3 | 4 |
|---|---|---|---|---|
| Remaining As³⁺ | 0.20 | 0.10 | 0.06 | 0.04 |
| Concentration | | | | |
| (As³⁺/ppm) | | | | |
| Removal | 99.80 | 99.90 | 99.94 | 99.96 |
| Efficiency % | | | | |

As shown in Table 4 and FIG. 22, similar results were shown and high removal efficiency of As³⁺ was obtained. 5 Arsenic was easier to remove than the 3 Arsenic and its removal efficiency of over 99% from almost all of the initial concentration was shown.

### Embodiment 4

### Recovery of Ag

According to the method of present invention, because the recovery of precious metals as well as the removal of harmful heavy metals are possible and, in reality, its economic value can be higher than the organics wastewater treatment and the power generation purposes only, it can be applied to various fields. Using a microbial fuel cell according to the present invention, the recovery of silver from the wastewater using the electrical energy from the silver-contained wastewater is the first of its kind. The formation of sufficient power is available with a forged battery module.

Gold and silver recovery from the solar photovoltaic industry and the electronics industry such as printed circuit boards (PCB) has enormous economic implications. As the usage of silver may be a factor to raise the production cost of solar cells and electronic devices, the recovery of silver from the electronic wastes may be able to contribute to the economy.

In the present invention, virtual electrolysis was conducted typically for about 3 hours for the recovery of silver by putting the carbon brush electrode in the anode chamber, the artificial wastewater acetic acid as a source of energy, and let microbes grow, in the cathode electrode, putting carbon cloth in 0.2M KNO₃ aqueous solution of the silver ion with 25˜200 ppm. In oxidation electrodes, carbon brushes as well as various carbon electrodes, such as carbon felt or graphite membrane plate are desirable to maximize the surface area of the cathode. Oxidation electrodes must be made to have much larger area as compared with the cathode area in order not to have any impact on the reaction of cathode (about over 10 times).

FIG. 23 is a graph to show change of voltage as a function of time using a microbial fuel cell according to the present invention under several Ag⁺ concentrations (25, 50, 100, 200 ppm). Experimental temperature of 30° C., and 1000Ω of the load were given. The following Table 6 and FIG. 24 show the recovery rate of Ag under several initial Ag+ concentrations (25, 50, 100, 200 ppm). The solution was analyzed using ICP-AES.

TABLE 6

| | Initial Ag+ | | | |
|---|---|---|---|---|
| | Concentration | | | |
| | 25 ppm | 50 ppm | 100 ppm | 200 ppm |
| | Ag Recovery | Ag Recovery | Ag Recovery | Ag Recovery |
| Time/h | Rate (%) | Rate (%) | Rate (%) | Rate (%) |
| 1 | 99.61 | 99.70 | 99.79 | 67.20 |
| 2 | 99.80 | 99.85 | 99.87 | 99.90 |
| 3 | 99.80 | 99.85 | 99.90 | 99.94 |

If we use a microbial fuel cell according to the present invention for the recovery of the silver, as shown in FIG. 23, in the initial concentration of 200 ppm with 1,000Ω load, voltage of 0.8 V 3.620 A/m was obtained, producing a voltage of 2.90 W/m². In addition, Table 6 and at FIG. 24, under the silver ion's initial concentration of 200 ppm, maximum 99.94% of the recoveries was shown. In case of concentration of 25 ppm, the remaining lowest silver ion fell down to 0.12 ppm level. In case of initial silver concentration of 25 ppm, it reaches at 0.049 ppm within 3 hours, and if we continue further electrolysis using longer time, we can get much lower level of concentration. From these results, the test module according to the present invention can have superior performance to remove or recover silver, and have a great potential to be a breakthrough in the application and utilization in this field.

In the system of preliminary experiments according to the present invention, while the recovery rate reaches 99.94%, approximately 64 Wh/kg of electric energy was obtained as a by-product. On the other hand, according to a conventional method, 5.77 KWh/kg of electric energy consumption was needed to achieve 94% silver recovery by electrical precipitation (Thasan Raju, Sang Joon Chung, and Il Shik Moon, Korean J. Chem. Eng., 2009, 26(4), 1053). Thus, as we can see that there is a big difference between the conventional silver recovery method and the recovery method according to the present invention, the recovery method of the present invention is expected to have a large economic impact.

It is meaningful that the method of the present invention can not only recover silver from the waste electronic devices or silver plating wastewater, but also be critical in recovering of silver by-product or refining silver minerals in the copper mines, and further produce a power supply.

The silver recovery method described in the above can be similarly applied to the case of other precious metals such as gold, and the results also can get similar or better results. The following examples illustrate the recovery of Au, Pd, Pt, Rh, Ir, and Re of, and represents higher than 99% recovery rate.

### Embodiment 5

### Au Recovery

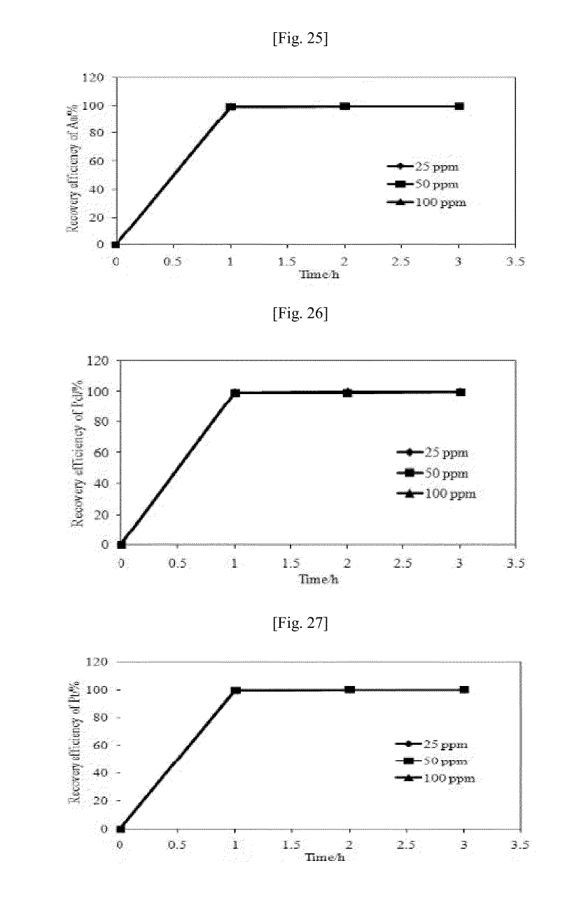

Gold recovery was experimented using AuCl³ standard solution similarly as the above-mentioned silver recovery. Following table 7 and FIG. 25 show the Au recovery as a function of time under several initial Au³⁺ concentrations (25, 50, 100 ppm) using microbial fuel cells according to the present invention. 0.2M KNO₃, and the experimental temperature was 30° C., with the load of 1,000Ω. Solution was analyzed using ICP-AES.

TABLE 7

| | Initial Concentration | | |
|---|---|---|---|
| | of Au³⁺ | | |
| | 25 ppm | 50 ppm | 100 ppm |
| | Au Recovery | Au Recovery | Au Recovery |
| Time/h | Efficiency (%) | Efficiency (%) | Efficiency (%) |
| 1 | 99.7 | 99.60 | 99.50 |
| 2 | 99.80 | 99.85 | 99.87 |
| 3 | 99.90 | 99.87 | 99.90 |

### Embodiment 6

### Pd Recovery

The recovery of palladium was conducted using PdCl₂ based solution in a similar way to the above-mentioned silver recovery method. Table 8 and FIG. 26 show the Pd recovery rate as a function of time at several initial Pd²⁺ concentrations (25, 50, 100 ppm) using a microbial fuel cell according to the present invention. 0.2M KNO₃ was used and experimental temperature was 30° C., with the load of 1,000Ω. Solution was analyzed using ICP-AES.

TABLE 8

| | Initial Concentration | | |
|---|---|---|---|
| | of Pd²⁺ | | |
| | 25 ppm | 50 ppm | 100 ppm |
| | Pd Recovery | Pd Recovery | Pd Recovery |
| Time/h | Efficiency (%) | Efficiency (%) | Efficiency (%) |
| 1 | 99.50 | 99.40 | 99.30 |
| 2 | 99.90 | 99.50 | 99.87 |
| 3 | 99.90 | 99.80 | 99.70 |

### Embodiment 7

### Pt Recovery

Recovery of platinum was conducted in a similar way to the above-mentioned silver recovery using solid reagents H₂PtCl₆ or K₂PtCl₆ solid and the following Table 9 and 27 showed the recovery of Pt as a function of time at various initial concentrations of Pt+(25, 50, 100 ppm) using a microbial fuel cell according to the present invention. 0.2 M of KNO₃ was used and the experimental temperature was 30° C., with the load of 1,000Ω. Solution was analyzed using ICP-AES.

TABLE 9

| | Initial Concentration | | |
|---|---|---|---|
| | of Pt⁴⁺ | | |
| | 25 ppm | 50 ppm | 100 ppm |
| | Pt Recovery | Pt Recovery | Pt Recovery |
| Time/h | Efficiency (%) | Efficiency (%) | Efficiency (%) |
| 1 | 99.7 | 99.60 | 99.40 |
| 2 | 99.90 | 99.82 | 99.80 |
| 3 | 99.90 | 99.87 | 99.87 |

### Embodiment 8

### Rh Recovery

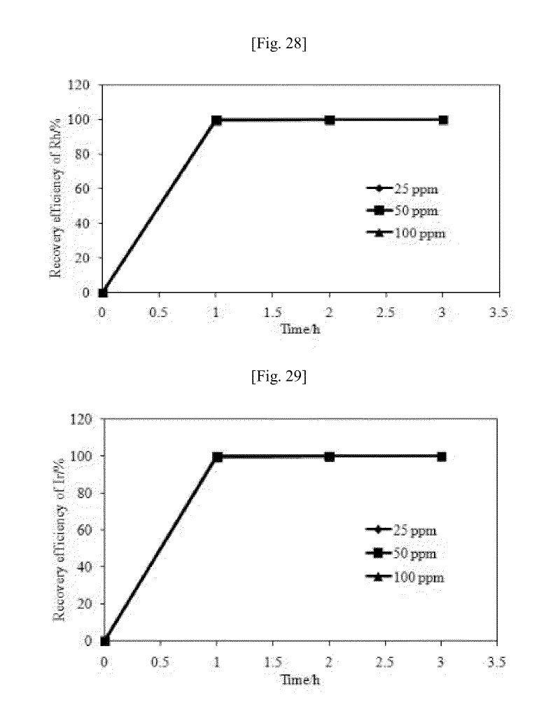

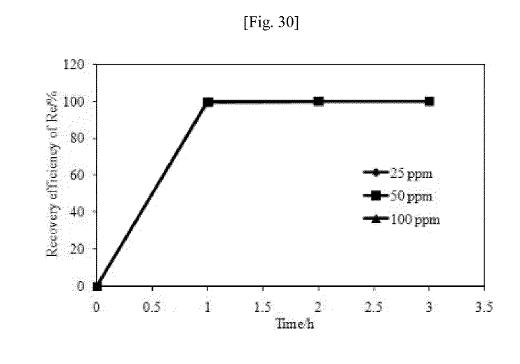

The recovery of rhodium was conducted in a similar way to the above-mentioned silver recovery using solid reagents RhCl₃. Following Table 10 and FIG. 28 showed Rh recoveries as a function of time at various Rh³⁺ concentrations (25, 50, 100 ppm) using a microbial fuel cell according to the present invention. 0.2M KNO₃ was used, and the experimental temperature was 30° C., with the load of 1,000Ω. Solution was analyzed using ICP-AES.

TABLE 10

| | Initial Concentration | | |
|---|---|---|---|
| | of Rh³⁺ | | |
| | 25 ppm | 50 ppm | 100 ppm |
| | Rh Recovery | Rh Recovery | Rh Recovery |
| Time/h | Efficiency (%) | Efficiency (%) | Efficiency (%) |
| 1 | 99.40 | 99.50 | 99.20 |
| 2 | 99.70 | 99.65 | 99.57 |
| 3 | 99.80 | 99.70 | 99.70 |

### Embodiment 9

### Ir Recovery

The recovery of iridium was conducted in a similar way to the above-mentioned silver recovery using IrCl₃ solid reagents. Following Table 11 and FIG. 29 showed Ir recovery as a function of time at several initial Ir³⁺ concentrations (25, 50, 100 ppm) using a microbial fuel cell according to the present invention. 0.2M of KNO₃ was used and the experimental temperature was 30° C., with the load of 1,000Ω. Solution was analyzed using ICP-AES.

TABLE 11

| | Initial Concentration | | |
|---|---|---|---|
| | of Ir³⁺ | | |
| | 25 ppm | 50 ppm | 100 ppm |
| | Ir Recovery | Ir Recovery | Ir Recovery |
| Time/h | Efficiency (%) | Efficiency (%) | Efficiency (%) |
| 1 | 99.37 | 99.26 | 99.12 |
| 2 | 99.65 | 99.53 | 99.47 |
| 3 | 99.72 | 99.63 | 99.54 |

### Embodiment 10

### Re Recovery

The rhenium recovery was conducted in a similar way to the above-mentioned silver recovery using solid reagents ReCl₃. The following Table 12 and figure showed the recovery of Re as a function of time at several initial Re³⁺ concentrations (25, 50, 100 ppm) using a microbial fuel cell according to the present invention. 0.2M KNO₃ was used with the experimental temperature of 30° C., and load of 1,000Ω. Solution was analyzed using ICP-AES.

TABLE 12

| | Initial Concentration | | |
|---|---|---|---|
| | of Re³⁺ | | |
| | 25 ppm | 50 ppm | 100 ppm |
| | Re Recovery | Re Recovery | Re Recovery |
| Time/h | Efficiency (%) | Efficiency (%) | Efficiency (%) |
| 1 | 99.35 | 99.25 | 99.16 |
| 2 | 99.56 | 99.47 | 99.29 |
| 3 | 99.87 | 99.64 | 99.43 |

Embodiments in the above are simple examples of the removal of mercury ions, chromium and arsenic ions from wastewater, and of the recovery of silver, gold, palladium, platinum, rhodium, iridium and rhenium ions. Those who are skilled in the art of this field will not have any difficulty in applying the present embodiment to the removal of heavy metals or the recovery of precious metal by the method according to the present invention.

### INDUSTRIAL APPLICABILITY

According to the present invention, heavy metal removal or precious metal recovery from wastewater will be available together with power generation using the MFC technology. In addition, especially Hg²⁺ can be effectively removed in the form of metallic Hg or Hg₂Cl₂ of solid precipitates or sediments, and removal of chromium and arsenic ions, and recovery of gold, platinum, palladium, rhodium, iridium and rhenium ions can be achieved with high efficiency. Especially in case the rear end voltage is not sufficient, by applying the shear end voltage to the rear end using a two-chamber MFC, many different kinds of ions can be removed or recovered.

1. Method of removal of heavy metals from wastewater containing heavy metals and power generation simultaneously using anaerobic microbes in a microbial fuel cell (MFC) with anode, cathode, and a the membrane between the two electrodes.

2. According to claim 1, wherein the method that is characterized of the removal of heavy metals which are Hg²⁺, Hg⁺, Cr⁶⁺, Cr⁵⁺, Cr⁴⁺, Cr³⁺, Cr²⁺, As⁵⁺, As³⁺, Co²⁺, Co³⁺, Cu²⁺, Cu⁺, U⁶⁺, Mn⁷⁺, Mo⁶⁺, Cd₂₊ or Pd²⁺ in claim 1.

3. According to claim 1, wherein the anaerobic microbes selected from the group consisting of at least one of the following: Alpha-proteobacteria, Beta-proteobacteria, Delta-proteobacteria, Clostridia, Shewanella oneidensis MR-1, Shewanella oneidensis DSP-10, Shewanella putrefaciens SR-21, IR-1, MR-1, Geobacter sulfurreducens, Geobacter sulfurreducens KN400, Ochrobactrum anthropi YZ-1, Brevibacillus sp. PTH1, E. coli K12 HB101, Aeromonas hydrophila, Corynebacterium sp. MFC03, Leptothrix discophora SP-6, Bacillus licheniformis, Bacillus thermoglucosidasius, Spirulina platensis, Bacillus subtilis, Enterococcus gallinarum, Acetobacter aceti, Gluconobacter roseus.

4. According to claim 1, wherein the method that is characterized of the microbial fuel cell which consists of anode and cathode of carbon materials including carbon felt, carbon cloth, carbon rod, carbon paper and carbon brush, and the membrane between the two electrode chambers including Cation Exchange Membrane (CEM), Composite membrane, Nylon membrane, or Anion exchange membrane (AEM).

5. According to claim 1, wherein the method that is characterized of the microbial fuel cell (MFC) which consists of more than two cells.

6. According to claim 1 or claim 5, wherein the method that is characterized of the removal of heavy metals which are Cr⁶⁺, Cr³⁺, As⁵⁺, As³⁺.

7. Method of recovery of precious metals from wastewater containing precious metals and power generation simultaneously using anaerobic microbial in a microbial fuel cell (MFC) with anode, cathode, and a the membrane between the two electrodes.

8. According to claim 7, wherein the method that is characterized of the recovery of precious metals which are Ag⁺, Au²⁺, Au⁺, Pd⁴⁺, Pd²⁺, Pt⁴⁺, Pt²⁺, Rh²⁺, Ir³⁺ or Re³⁺.

9. According to claim 7, wherein the anaerobic microbial selected from the group consisting of at least one of the following: Alpha-proteobacteria, Beta-proteobacteria, Delta-proteobacteria, Clostridia, Shewanella oneidensis MR-1, Shewanella oneidensis DSP-10, Shewanella putrefaciens SR-21, IR-1, MR-1, Geobacter sulfurreducens, Geobacter sulfurreducens KN400, Ochrobactrum anthropi YZ-1, Brevibacillus sp. PTH1, E. coli K12 HB101, Aeromonas hydrophila, Corynebacterium sp. MFC03, Leptothrix discophora SP-6, Bacillus licheniformis, Bacillus thermoglucosidasius, Spirulina platensis, Bacillus subtilis, Enterococcus gallinarum, Acetobacter aceti, Gluconobacter roseus.

10. According to claim 7, wherein the method that is characterized of the microbial fuel cell which consists of anode and cathode of carbon materials including carbon felt, carbon cloth, carbon rod, carbon paper and carbon brush, and the membrane between the two electrode chambers including Cation Exchange Membrane (CEM), Composite membrane, Nylon membrane, or Anion exchange membrane (AEM).

11. According to claim 7, wherein the method that is characterized of the microbial fuel cell(MFC) which consists of more than two cells.

12. Method of removal of Hg²⁺ in the form of Hg₂Cl₂ solid precipitates or sediments from the mercury-containing wastewater and power generation simultaneously using anaerobic microbial in a microbial fuel cells (MFC) with anode, cathode, and a the membrane between the two electrodes

13. Alpha-proteobacteria, Beta-proteobacteria, Delta-proteobacteria, Clostridia, Shewanella oneidensis MR-1, Shewanella oneidensis DSP-10, Shewanella putrefaciens SR-21, IR-1, MR-1, Geobacter sulfurreducens, Geobacter sulfurreducens KN400, Ochrobactrum anthropi YZ-1, Brevibacillus sp. PTH1, E. coli K12 HB101, Aeromonas hydrophila, Corynebacterium sp. MFC03, Leptothrix discophora SP-6, Bacillus licheniformis, Bacillus thermoglucosidasius, Spirulina platensis, Bacillus subtilis, Enterococcus gallinarum, Acetobacter aceti, Gluconobacter roseus.

14. According to claim 12, wherein the method that is characterized of the microbial fuel cell which consists of anode and cathode of carbon materials including carbon felt, carbon cloth, carbon rod, carbon paper and carbon brush, and the membrane between the two electrode chambers including Cation Exchange Membrane (CEM), Composite membrane, Nylon membrane, or Anion exchange membrane (AEM).

15. According to claim 12, wherein the method that is characterized of the microbial fuel cell(MFC) which consists of more than two cells.

16. According to claim 12, wherein the method that is characterized of adjusting the initial pH of the mercury-containing wastewater to 2˜4.8.

17. According to claim 12, wherein the method that is characterized of adjusting the initial pH using dilute hydrochloric acid.

18. According to claim 12, wherein the method that is characterized of adjusting initial Hg²⁺ concentration of mercury-containing wastewater as 25˜100 mg/L.
